(19) United States
(12) Patent Application Publication
(10) Pub. No.: US 2024/0173622 A1
(43) Pub. Date: May 30, 2024

(54) IN-STREAM OBJECT INSERTION

(71) Applicant: Bidstack Group PLC, London (GB)

(72) Inventor: Arvids KOKINS, London (GB)

(21) Appl. No.: 18/070,182

(22) Filed: Nov. 28, 2022

(51) Int. Cl. A63F 13/61; A63F 13/53

(52) U.S. Cl. CPC A63F 13/61; A63F 13/53; A63F 2300/5506

(57) ABSTRACT

A computer-implemented method includes obtaining an input image frame of an input video stream, determining a statistically significant region of a color space represented by pixels of the input image frame, and generating an output image frame of an output video stream by overlaying an object on pixels of the input image with colors corresponding to the statistically significant region of the color space.

### BACKGROUND OF THE INVENTION

### Field of the Invention

The present disclosure relates to inserting a digital object into a video stream. The disclosure has particular, but not exclusive, relevance to inserting advertising content into a video game stream.

### Description of the Related Technology

The rise in popularity of video games and the increasing availability of high-speed internet connections have led to the emergence of video game streaming as a popular pastime. In video game streaming, a potentially large number of viewers stream footage of video game play, either in real time (so-called live streaming) or at a later time. The footage may be accompanied by additional audio or video, such as commentary from the player(s) and/or camera footage showing reactions of the player(s) to events in the video game.

Video game developers are increasingly pursuing revenue streams based on the sale of advertising space within video games. Adverts may for example be presented to a user as part of a loading screen or menu, or alternatively may be rendered within a computer-generated environment during gameplay, leading to the notion of in-game advertising. For example, in a sports game, advertising boards within a stadium may present adverts for real-life products. In an adventure game or first-person shooting game, adverts for real-life products may appear on billboards or other objects within the game environment. In order to facilitate this, a software development kit (SDK) or other software tool may be provided as part of the video game code to manage the receiving of advertising content from an ad server and insertion of advertising content into the video game.

A single instance of an advert appearing within a video game stream may lead to hundreds or thousands of “impressions” of the advert. In cases where an advert is inserted into the video game itself, for example via an SDK, any appearance of the advert during gameplay will lead to an appearance of the advert within the corresponding stream. However, in some cases inserting the advert into the video game may be impracticable and/or undesirable, for example where a video game does not include a suitable SDK or where the advert is intended for viewers of the stream but not for the video game player. Mechanisms for inserting advertising content into a video game environment typically rely on having at least some level of access to the game engine which controls the layout and appearance of the environment. Such mechanisms are not typically available in the streaming context, because the environment is generated and rendered at the video game system and no access to the game engine is provided downstream.

### SUMMARY

According to aspects of the present disclosure, there are provided a computer-implemented method, a computer program product such as a non-transient storage medium carrying instructions for carrying out the method, and a system comprising at least one processor and at least one memory storing instructions which, when executed by the at least one processor, cause the at least one processor to carry out the method. There is also provided a data processing system comprising means for carrying out the method.

The method includes obtaining an input image frame of an input video stream, determining a statistically significant region of a color space represented by pixels of the input image frame, and generating an output image frame of an output video stream by overlaying an object on pixels of the input image with colors corresponding to the statistically significant region of the color space.

By overlaying the object on pixels corresponding to the statistically significant region of the color space, the object will appear to be occluded by other objects appearing in the input image frame with colors not corresponding to the statistically significant region of the color space. In this way, the object can be inserted into the input image frame so as to appear as part of a scene depicted in the input image frame, with relatively little reliance on additional data (such as an occlusion map) or code (such as a game engine). Determining a statistically significant region of a color space may be performed in a relatively small number of processing operations, enabling insertion of objects into image frames of a video stream (for example, a live video game stream) in real-time or near-real-time.

The method may further include determining a spatial configuration of one or more features of a predetermined set of features within the input image frame, determining a transformation relating the determined spatial configuration of the one or more features to a default spatial configuration of the one or more features, and transforming the object in accordance with the determined transformation prior to the overlaying. In this way, an appropriate location, scale, and/or orientation of the object can be determined such that the object appears plausibly and seamlessly as part of the scene. The default spatial configuration may for example be a planar spatial configuration. The transformation may for example be a rigid body transformation or a perspective transformation.

Determining the spatial configuration of the one or more features within the image frame may include identifying points on a plurality of paths across the input image frame at which adjacent pixels colors change in a mutually consistent manner, connecting the identified points between paths of the plurality of paths to generate a chain of points, and identifying a first feature of the predetermined set of features based on the generated chain of points. This may enable features of a certain type (such as field lines on a sports field) to be detected in a computationally efficient and reliable manner.

Determining the spatial configuration of the one or more features within the image frame may include identifying a plurality of line segments in the input image frame, and determining locations within the input image frame of intersection points between at least some of plurality of line segments. The determined spatial configuration may then include the determined locations of the intersection points within the input image frame. The orientation and position of a planar region with predetermined features, such as a sports field, may for example be determined based on a small number of intersection points (for example, three intersection points) or a combination of intersection points, directions of straight line segments and/or curvatures of curved line segments etc. Determining the spatial configuration may further include classifying the intersection points, for example based on spatial ordering, relative positions, and/or other visual cues in the input image frame.

Determining the spatial configuration of the one or more features within the image frame may include identifying a plurality of line segments in the input image frame, determining a vanishing point based on at least some of the plurality of line segments, discarding a first line segment of the plurality of line segments based at least in part on the first line segment not pointing towards the vanishing point, and determining the spatial configuration in dependence on line segments of the plurality of line segments remaining after the discarding of the first line segment. In one example, a horizontal line scan is performed to detect line segments corresponding to field lines of a sports field. Field lines detected in the horizontal line scan that are substantially parallel to one another in the environment, and have a similar direction in the environment to the direction from which the sports field is viewed, will generally point towards the vanishing point. Discarding straight line segments detected by the horizontal line scan, but not pointing towards the vanishing point, may filter out erroneously detected lines or lines which are not useful for determining the position, dimensions, and/or orientation of the sports field.

The determined spatial configuration of the one or more features may further be used to determine a dimension associated with the default spatial configuration of the one or more features. In certain settings, dimensions of certain features such as penalty boxes on a football field may by strictly defined, whereas other dimensions such pitch length may be variable and not known a priori. The unknown dimensions may be determined, either absolutely or relative to the known dimensions, by analysing the determined spatial configuration of features for a suitable input image frame, such as an image frame in which the entirety or a large proportion of a football field is visible. The unknown dimensions may be measured and recorded once within a given video stream. The relative dimensions may be relevant for determining a location at which to place the object.

Determining the transformation may be based at least in part on the spatial configuration of the one or more features within a plurality of image frames of the input video stream. Using information from multiple image frames, for example by averaging and/or using a sliding window or moving average approach, may temporally stabilize the position of the object in the output video stream.

Generating the output video data may include generating mask data pixels of the input image frame with colors in the determined statistically significant region of the color range, and overlaying the object on pixels of the input image frame indicated by the mask data. The mask data may represent a binary mask indicating on which pixels of the input image frame it is permissible to overlay part of the object. Alternatively, the mask data may represent a soft mask with values that vary continuously from a first extremum for pixels with colors inside the statistically significant region of the color space to a second extremum for pixels with colors outside the statistically significant region of the color space. The overlaying may then include blending the object with pixels of the input image frame in accordance with the values indicated by the mask data. By using a soft mask in this way, artefacts in which the appearance of the object is interrupted due to color variations close to a boundary of the statistically significant region may be mitigated or avoided.

Determining the statistically significant region of the color space for pixels of the input image frame may include determining a statistically significant range of values of a first color channel for pixels of the input image frame, and determining a statistically significant range of values of a second color channel for pixels of the input image frame with values of the first color channel within the statistically significant range. The statistically significant region of the color range may then include values of the first and second color channels in the determined statistically significant ranges. By filtering the pixels based on the first color channel, and then analyzing the remaining pixels based on the second color channel, the compute overhead is reduced compared with analysing all color channels for all pixels of the input image frame (or a downscaled version of the input image frame). The first color channel may be selected to provide maximum discrimination between regions of interest and other regions. For example, the input image frame may depict a substantially green region depicting grass, which case the first color channel may be a red color channel.

Determining the statistically significant region of the color space for pixels of the input image frame may further include determining a statistically significant range of values of a third color channel for pixels of the input image frame with values of the first color channel within the statistically significant range for the first color channel and values of the second color channel in the statistically significant range for the second color channel. The statistically significant region of the color range may then include values of the first, second, and third color channels in the determined statistically significant ranges for first, second, and third color channels. Nevertheless, in other examples the third color channel may not be analyzed, and the statistically significant region of the color space may be defined in terms of two color channels.

The statistically significant region of the color space may be a first statistically significant region of the color space, and the method may further include determining a second statistically significant region of the color space represented by pixels of the input image frame. Generating the output image frame may then further include overlaying the object on pixels of the input image frame with colors corresponding to the second statistically significant region of the color space. In some situations, areas in which it is permissible to insert the object may correspond to several different regions of the color space. For example, different lighting conditions caused by shadows and/or different colors of grass caused by a mowing pattern.

The method may further include downscaling the input image frame prior to determining the statistically significant region of the color space represented by pixels of the input image frame. In this way, the processing cost and memory use associated with determining the statistically significant region of the color space may be reduced drastically without significantly affecting the accuracy of determining the statistically significant region of the color space.

The input image frame may include a set of input pixel values, and the operations may further include applying a blurring filter to at least some input pixel values of the input image frame to generate blurred pixel values for the input image frame, determining lighting values for the input pixels values based at least in part on the input pixel values and the blurred pixel values, and modifying colors of the transformed object in dependence on the determined lighting values prior to the overlaying.

The input image frame may be a first image frame of a sequence of image frames within the input video stream, and the method may further include determining that the object is not to be overlaid on a second image frame subsequent to the first image frame in the input video stream, and generating a sequence of image frames of the output video stream by overlaying the object on pixels of image frames between the first image frame and the second image frame in the input video stream. An opacity of the object may vary over a course of the sequence of image frames, thereby to progressively fade the object out of view in the output video stream. For example, a delay of several frames may be introduced between determining whether the object is to be overlaid on the first image frame and the process of generating a corresponding frame of the output video stream. If the object cannot be overlaid on the first image frame, or if it is otherwise determined not to overlay the object on the first image frame, the object can be faded out over several frames. The method may subsequently include determining that the object is to be overlaid on a third image frame subsequent to the second image frame in the input video stream, and generating a second sequence of image frames of the output video stream by overlaying the object on pixels of image frames following the third image frame in the input video stream. The opacity of the object may vary over a course of the second sequence of image frames, thereby to progressively fade the object into view in the output video stream. Fading the object into and out of view in this way may mitigate undesirable artefacts in which the object flashes rapidly in and out of view for sequences of image frames where the image processing is unstable.

Determining the statistically significant region of the color space may be based at least in part on colors of pixels of a plurality of image frames of the input video stream. This may improve the robustness of the method to anomalous image frames in which a region of interest is highly occluded.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 schematically shows a system for video game streaming in accordance with examples.

FIG. 2 shows functional components of an ad insertion module in accordance with examples.

FIG. 3 shows schematically a set of histograms used to determine a statistically significant region of a color space in accordance with examples.

FIGS. 4A-4G illustrate a set of optional steps for inserting an object into an image frame.

FIG. 5 shows illustrates a vanishing point in accordance with examples.

FIG. 6 shows schematically an example in which an object is faded out of view over a sequence of image frames.

FIG. 7 shows schematically an example in which an object is faded into view over a sequence of image frames.

FIG. 8 is a flow diagram representing a method of managing computing resources according to examples.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further notes that certain examples are described schematically with certain features omitted and/or necessarily simplified for the case of explanation and understanding of the concepts underlying the examples.

Embodiments of the present disclosure relate to inserting objects into video data, for example a video stream featuring footage of video game play. In particular, embodiments described herein address problems relating to inserting objects so as to appear within a computer-generated scene, where access is not available to code or data used to generate and render the scene.

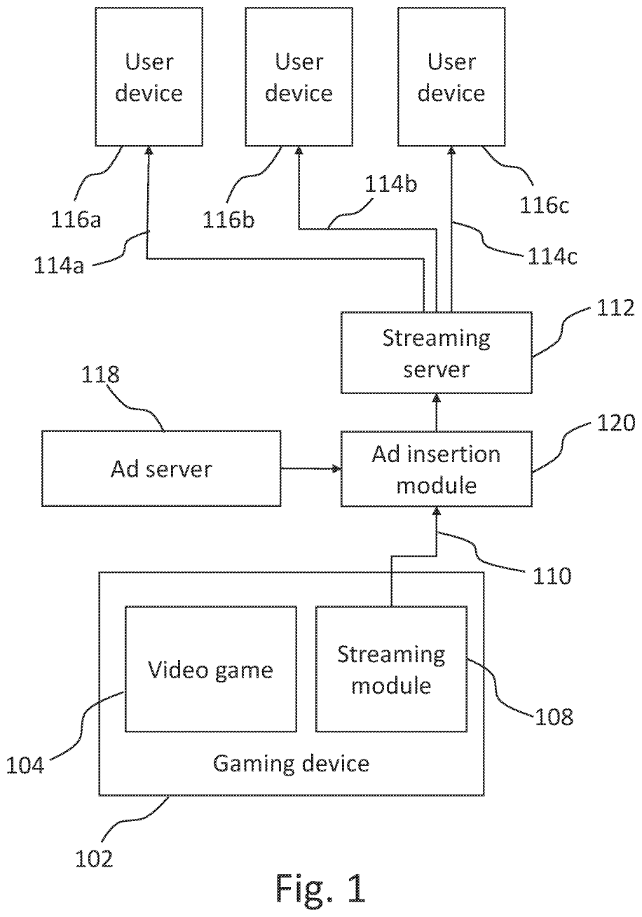

FIG. 1 shows an example of a system including a gaming device 102 arranged for one or more users (referred to hereafter as gamers) to play a video game 104. The gaming device 102 can be any electronic device with processing circuitry capable of processing video game code to output a video signal to a display device in dependence on user input received from one or more input devices. The gaming device 102 may for example be a personal computer (PC), a laptop computer, a tablet computer, a smartphone, a games console, a smart tv, a virtual/augmented reality headset with integrated computing hardware, or a server system arranged to provide cloud-based gaming services to remote users. The gaming device 102 may be arranged to store the video game 104 locally, for example after downloading the video game 104 over a network, or may be arranged to read the video game 104 from a removable storage device such as an optical disc or removable flash drive.

The gaming device 102 includes a streaming module 108 arranged to enable transmission of a video game stream 110 featuring footage of the video game 104 being played, directly or indirectly to a streaming server 112. The video game stream 110 may be transmitted to the streaming server 112 in substantially real-time (for example, to enable a live stream of video game play), or may be transmitted asynchronously from the video game 104 being played, for example in response to user input at the gaming device 102 after the gaming session has ended. The video game stream 110 may include a sequence of image frames and, optionally, an associated audio track. The video game stream 110 may further include footage and/or audio of the gamer playing the video game 104, recorded using a camera and microphone. The gamer may for example narrate the gameplay or otherwise share their thoughts to create a more immersive experience for viewers of the video game stream 110.

The streaming server 112 may include a standalone server or a networked system of servers, and may be operated by a streaming service provider such as YouTube®, Twitch® or HitBox®. The streaming server 112 may be arranged to transmit modified video game streams 114 to a set of user devices 116 (of which three—user devices 116a, 116b, 116c—are shown). In some examples, the same modified video game stream 114 is transmitted to all of the user devices 116. In other examples, different modified video game streams 114 may be transmitted to different user devices 116. The modified video game stream(s) 114 may be transmitted to the user devices 116 as live streams (substantially in real-time as the video game 104 is played) or asynchronously, for example at different times when the user devices 116 connect to the streaming server 110. In the present example, the modified video game stream(s) 114 differ from the original video game stream 110 generated by the gaming device 102 in that the modified video game stream(s) 114 include additional advertising content. Depending on commercial arrangements, inserting advertising content into a video game stream may provide additional revenue to the operator of the streaming server and/or the developer of the video game 104.

The streaming server 112 in this example is communicatively coupled to an ad insertion module 120 responsible for processing the original video game stream 110 to generate the modified video game stream(s) 114. For example, the ad insertion module 120 may modify image frames of the input video stream 110 by inserting advertisement content received from an ad server 118. The ad server 118 may be operated for example by a commercial entity responsible for managing the distribution of advertising content on behalf of advertisers, or directly by an advertiser, or by the same commercial entity as the streaming server 112.

Although in this example the ad insertion module 120 is shown as separate from any of the other devices or systems in FIG. 1, in other examples the functionality of the ad insertion module 120 may be provided by the streaming server 112, the ad server 118, the gaming device 102, or one of the user devices 116, for example being embodied as a separate software module in any of these devices or systems. Alternatively, the ad insertion module 120 may be part of a standalone computing device or system located at any point between these components.

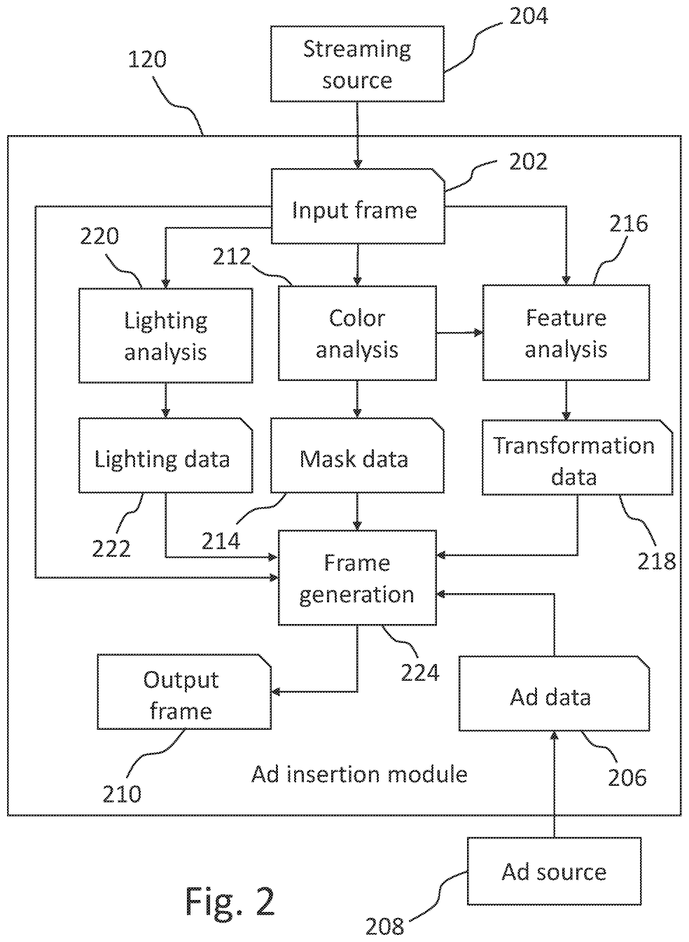

Functional components of the ad insertion module 120 are shown in FIG. 2. The various components may for example be separate software modules or may be combined in a single computer program. The functional components shown in FIG. 2 are optional, and in other examples, one or more of the functional components may be omitted. One or more of the functional components shown in FIG. 2 may be used to process an input frame 202 of an input video stream received from a streaming source 204 and ad data 206 received from an ad source 208, to generate an output frame 210. The streaming source 204 may be the streaming module 108 of the gaming device 102 of FIG. 1. In one example, the input frame 202 is a single image frame of the video game stream 110 generated by the gaming device 102, and the output frame 206 is a single image frame of a modified video game stream 114 to be transmitted to a user device 116. The ad data 206 may include a two-dimensional object such as an image or a frame of a video. Alternatively, or additionally, the ad data 206 may include data defining a three-dimensional object, such as a mesh model, a point cloud, a volumetric model, or any other suitable representation of a three-dimensional object.

The ad insertion module 120 in this example includes a color analysis component 212, which is arranged to determine one or more statistically significant regions of a color space represented by pixels of the input frame 202, and to identify pixels of the input frame 202 falling within each determined statistically significant region of the color space. A region of a color space may for example include a respective range of values for each of a set of color channels, such as red, green, blue color channels in the case that the image frame is encoded using an RGB color model. A given region of the color space may therefore encompass a variety of spectrally similar colors. A statistically significant region of a color space may for example be a most represented region of the color space by pixels of the input frame 202. In an example of a video game stream featuring footage of a football (soccer) game, a statistically significant region of a color space may represent a range of greens corresponding to grass on a football pitch. Several statistically significant regions may correspond to different shades of grass (e.g. resulting from a mowing pattern) in sunshine and in shade. In an example where a video game stream features footage of a city, a statistically significant region of a color space may represent a dark gray color corresponding to tarmac of a road. Several statistically significant regions may correspond to tarmac under different lighting conditions. The number of statistically significant regions may depend on various factors such as the type of scene depicted in the image frame 202. The color analysis component 212 may be configured to identify a predetermined number of statistically significant regions of the color space (e.g. depending on the type of video game) or may determine automatically how many statistically significant regions of the color space are represented by pixels of the image frame 202. As will be explained in more detail hereinafter, pixels of the input frame 202 falling within the statistically significant regions of the color space may correspond to a region of interest within the input frame 202 and may be candidate pixels on which advertisement content can be inserted.

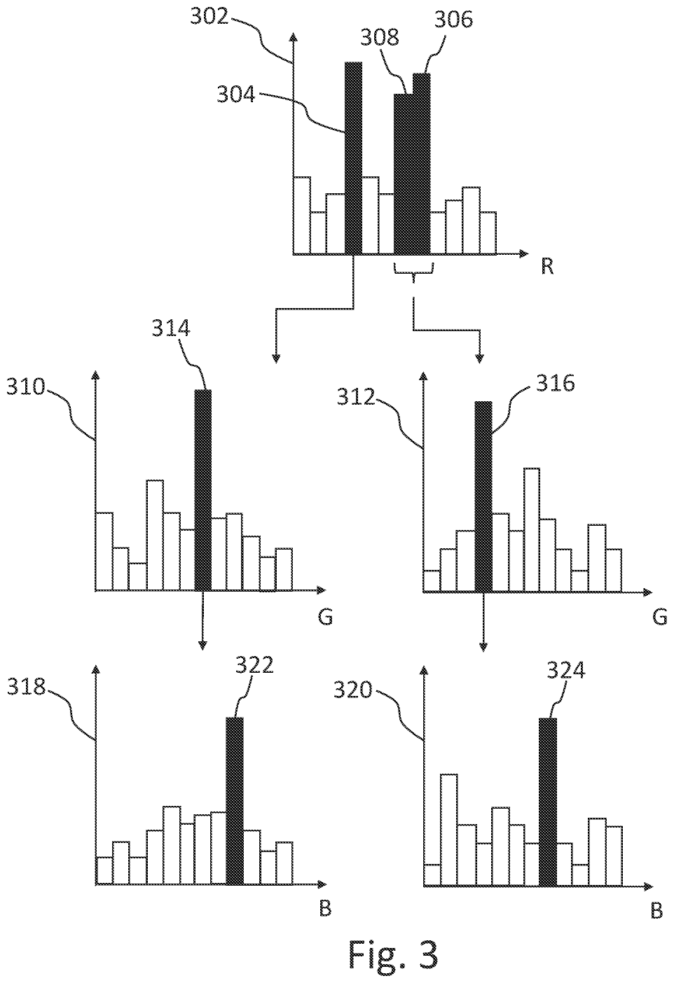

FIG. 3 illustrates an example of a method of determining statistically significant regions of a color space represented by pixels of an image frame encoded using the RGB color model. In this example, the image frame is taken from footage of a football game, and the statistically significant regions of interest may correspond to grass of a football pitch. First, values of the red channel for the pixels are quantized and the pixels of the image frame are allocated to bins corresponding to the quantized values. Next, one or more statistically significant ranges of the red channel are determined, based on the numbers of pixels allocated to the bins. In FIG. 3, the histogram 302 shows two statistically significant ranges of the red color channel. The first statistically significant range corresponds to the most represented histogram bin 304. The second statistically significant range corresponds to the two next most represented histogram bins 306, 308. In this example, the neighboring bins to the most represented bin 304 contain significantly fewer pixels than those in the most represented bin 304, and therefore the bin 304 alone may be considered to correspond to a statistically significant range. The second most represented bin 306 is adjacent to a similarly well-represented bin 308. Therefore, the union of the second most represented bin 306 and its neighboring bin 308 may be considered to correspond to a statistically significant range. The number of statistically significant ranges may be predetermined (for example based on prior knowledge of the expected distribution of colors within a scene of a video game) or may be inferred from the histogram, for example by counting how many locally modal bins appear within the histogram.

In this example, for each statistically significant range of the red channel determined within the image frame, values of the green channel are quantized and the pixels falling within each statistically significant range of the red channel are allocated to bins corresponding to the quantized values of the green channel. For the pixels falling within each statistically significant range of the red channel, one or more statistically significant ranges of the green channel are determined, and a record is kept of which of those pixels fall within the determined ranges of the green channel. For each statistically significant range of the red channel, the number of statistically significant ranges of the green channel may be predetermined (for example, one), or may be inferred as discussed in relation to the red channel. In FIG. 3, separate histograms 310, 312 are shown for the two statistically significant ranges of the red channel, and one statistically significant range of the green channel is determined within each histogram 310, 312, corresponding to the bins 314, 316

In this example, the analysis applied to the green channel is then repeated for the blue channel. Specifically, for each statistically significant region of the green channel determined above, values of the blue channel are quantized, and the pixels of the image frame are allocated to bins corresponding to the quantized values of the blue channel. For the pixels falling within each statistically significant range of the green channel, one or more statistically significant ranges of the blue channel are determined. For each statistically significant range of the green channel, the number of statistically significant ranges of the blue channel may be predetermined (for example, one), or may be determined automatically as discussed in relation to the red channel. In FIG. 3, separate histograms 318, 320 are shown for the two statistically significant ranges of the green channel, and one statistically significant range of the blue channel is determined within each histogram 318, 320, corresponding to the bins 322, 324. Pixels associated with the bins 322, 324 may be identified as having colors falling within statistically significant regions of the color space.

The method described with reference to FIG. 3 is an example that involves filtering out pixels based on one color channel at a time. This may be implemented by rescanning the pixels at each stage, with additional range criteria added at each stage, or alternatively by keeping a record of which pixels of the image frame fall within the identified range(s) for each color channel. In this way, the full set of pixels may be analyzed for the first color channel, and then progressively fewer pixels are analyzed for each subsequent color channel. As a result, the method is computationally efficient at determining statistically significant regions of the color space and identifying pixels falling within the statistically significant regions of the color space. The efficiency and accuracy of the method may be optimized by ordering the color channels auspiciously. For example, the red channel may be the best discriminator between substantially green and non-green regions of the image frame, so it may be advantageous to analyze the red color channel first, followed by the green and blue channels, in an example where advertisements are to be inserted on substantially green regions of an image frame (e.g. on grass on a sports field). In particular, green and white regions may have similarly strong green components, making it difficult to distinguish between green regions (e.g. grass) and white regions (e.g. field lines) using the green channel. In other examples, it may be more appropriate to analyze the green or blue channel first, depending on which color channel is best able to discriminate regions of interest from other regions of an image frame. The blue channel typically has less effect on the luminance of a pixel than the green channel, and therefore it may be beneficial to analyze the green channel before the blue channel. In some examples, it may be sufficient to analyze two color channels or even one color channel to identify statistically significant regions of a color space. In other examples, color channels may not be analyzed one after the other, but instead the entire color region may be quantized, and statistically significant regions may be determined based on the resulting multi-dimensional histogram. It is to be noted that, while in the example of FIG. 3 the number of histogram bins is chosen as twelve, in other examples more or fewer histogram bins may be used. An appropriate number of histogram bins (for example ten, twenty, fifty or one hundred) may be determined during a configuration process. The number of histogram bins should be large enough to be able to distinguish regions of interest from other regions of the image frame, though larger numbers of bins may require more sophisticated methods of determining the statistically significant ranges, to account for the possibility of small gaps within the relevant range(s).

Color analysis methods such as those described above may be used to determine regions of interest of an image frame in a computationally efficient manner. The efficiency may be improved further by downscaling the input frame prior to performing the color analysis. For example, one or more iterations of straightforward downsampling, pixel averaging, median filtering, and/or any other suitable downscaling method may be applied successively to downscale the image frame. To achieve a balance between computational efficiency of the downsampling process and retaining sufficient information from the original image frame, initial iterations may be performed using straightforward downsampling, and later iterations may be performed using a more computationally expensive downscaling algorithm such as median sampling. For example, an image frame with 1920×1080 pixels may first be downsampled using three iterations of 2× downsampling, then subsequently downsampled using three iterations of median filtering, resulting in a downscaled image frame of 30×16 pixels, on which the color analysis may be performed.

Other examples of methods of determining regions of interest may be used, including semantic segmentation, which may similarly be used to identify pixels associated with particular regions of interest. However, performing inference using a semantic segmentation model may be computationally more expensive than color analysis methods (particularly if downscaling is applied for the color analysis) and therefore may be less suitable for real-time processing of video stream data. Furthermore, semantic segmentation may require significant investment in time and resources to obtain sufficient labeled training data to achieve comparable levels of accuracy for a given video game or type of video game. Other possible methods may analyze motion to determine regions of interest on which objects can be overlaid, for example by comparing pixels of a given image frame to pixels of a neighboring or nearby image frame to determine motion characteristics for pixels of the given image frame (e.g. in the form of optical flow data, displacement maps, velocity maps, etc.). Pixels with anomalous motion characteristics (e.g. having velocities inconsistent with a majority of pixels in a relevant region of the image frame) may be excluded as being associated with dynamic entities (such as a player or a ball) as opposed to a background region (such as a sports field). It will be appreciated that different approaches to detecting regions of an image frame may be used in the event that an initial approach fails, or several approaches may be used in conjunction with one another.

In the examples described above, color ranges associated with regions of an image frame are inferred by analyzing pixel colors, enabling the method to be used for a range of video games or other video stream sources, in some cases with little or no prior knowledge of the video stream source, and providing robustness against variations in color characteristics between video streams and/or between image frames. However, in other examples, colors or ranges of colors associated with regions of interest may be measured or otherwise known a priori, in which case determining a statistically significant region of the image frame may include reading the appropriate ranges of one or more color values from memory.

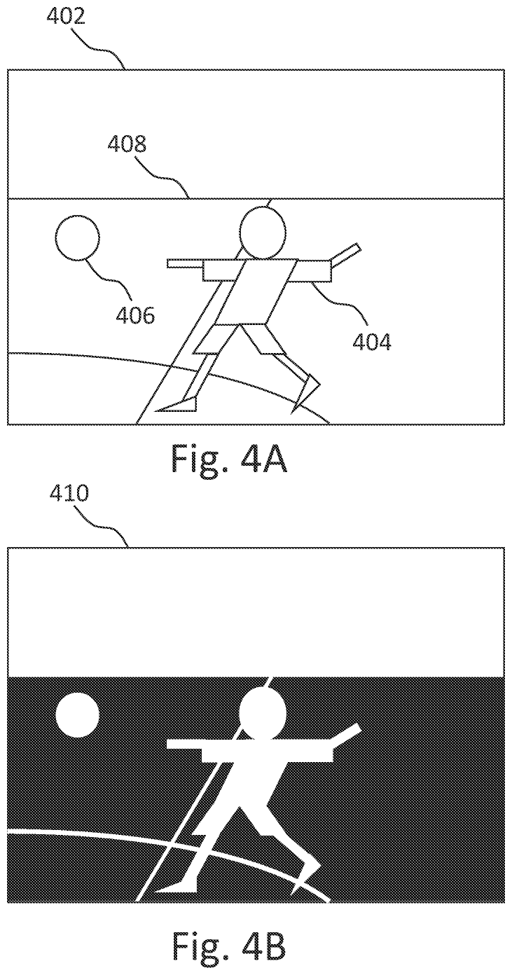

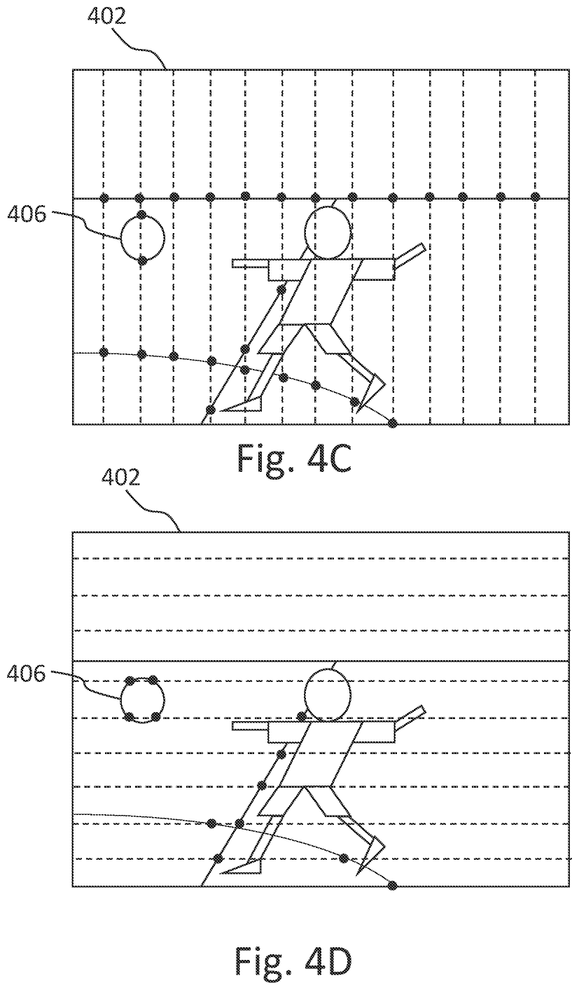

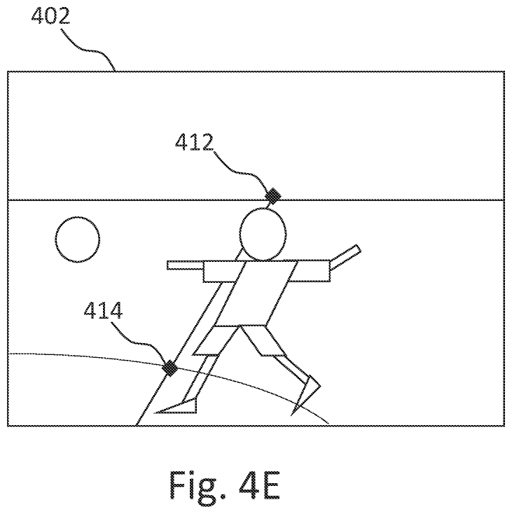

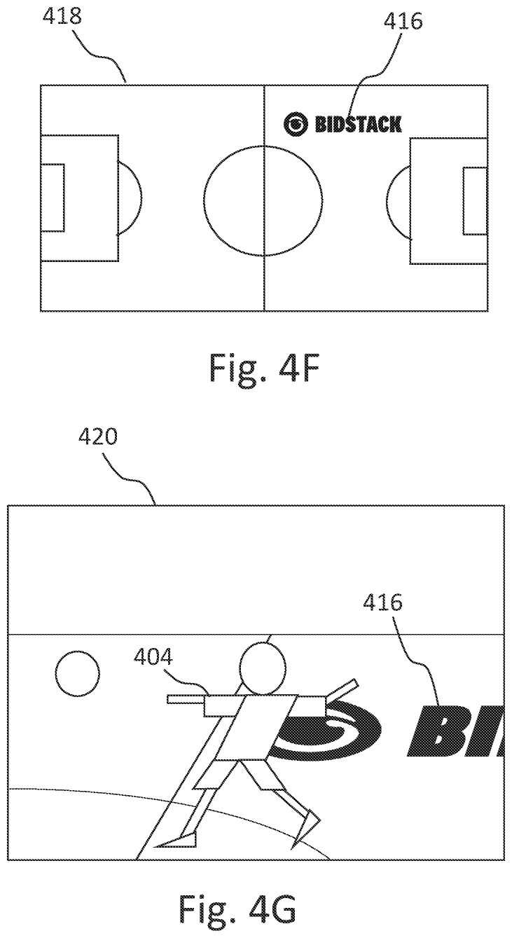

The color analysis component 212 is arranged to generate mask data 214 indicating pixels of the input frame 202 with color values falling within the identified statistically significant region(s) of the color space. The mask data 214 may include a binary mask indicating pixels falling into any of the identified statistically significant regions. Alternatively, the mask may be a soft threshold mask with values that vary continuously with color from a maximum value inside the statistically significant region to a minimum value outside the statistically significant region (or vice-versa). A mask of this type may result in fewer artefacts being perceived by viewers, for example where a color of an object in the input frame 202 fluctuates close to the boundary of the color region. Additionally, or alternatively, the mask data 214 may indicate pixels falling into specific statistically significant regions of the color space, for example using different values or using different mask channels. The mask data 214 may indicate pixels on which it is permissible for an object such as an advertisement to be overlaid. For example, in a sports game it may be permissible to overlay an advertisement on pixels corresponding to a sports field, but not on pixels corresponding to players or other objects that may lie outside the sports field and/or may occlude the sports field. FIG. 4A shows an example of an image frame 402 showing of a football player 404 and a football 406 occluding part of a football pitch 408. FIG. 4B shows a binary mask 410 in which pixels corresponding to one or more statistically significant regions of a color space are shown in black and pixels not corresponding to the one or more statistically significant regions of the color space are shown in white. It is observed that, in this example, the binary mask indicates the (unpainted) regions of grass visible in the image frame 402.

Returning to FIG. 2, the ad insertion module 120 may include a feature analysis component 216, which is arranged to analyze features appearing within the input frame 202 to determine a transformation to be applied to an object, such as an advertisement, to be inserted into the input frame 202. In particular, the feature analysis component 216 may be arranged to determine a spatial configuration of the features appearing within the input frame 202. The features may be instances of features from a predetermined set. For example, in the case of a sports game, the predetermined set of features may correspond to field lines on the sports field. The spatial configuration of the features in the image frame may include positions and/or orientations of the features relative to one another and/or relative to a two-dimensional coordinate system of the image frame. A transformation may then be determined for mapping a default or predetermined spatial configuration of the features to the determined spatial configuration in the image frame. The default spatial configuration may for example include positions of features of the sports field at a predetermined orientation in two dimensions, though in other cases (such as when a region of interest is not planar) the default spatial configuration may correspond to an environment viewed from a default perspective in three dimensions. The determined transformation, or a related transformation, may then be used to transform an object such as an advert to be inserted into the input frame 202, so as to appear at an intended position and orientation in the input frame 202. The determined transformation may be stored as transformation data 218, which may for example include a matrix or vector representing a rigid transformation, or a perspective matrix.

The ad insertion module 120 may identify features within the input frame 202 using any suitable image processing method. For example, an object detection model trained using supervised learning may be suitable for identifying visually distinctive features such as may appear in certain video game environments. In an example in which the features correspond to lines on a sports field, a method of identifying features may instead use horizontal and vertical line scans to identify changes of pixel color, for example from green to white or vice-versa, or between different shades of green. A set of vertical line scans evenly spaced across the width of the input frame 202 may be used to detect field lines substantially in the horizontal direction of the input frame 202 (for example, field lines angled at less than 45 degrees from the horizontal direction). A set of horizontal line scans evenly spaced across the height of the input frame 202 may be used to detect field lines substantially in the vertical direction of the input frame 202 (for example, field lines angled at less than 45 degrees from the vertical direction). FIG. 4C shows an example in which pixels of an image frame 402 lying a set of equally spaced vertical lines are scanned to detect changes of pixel color. A first chain of points at which pixel colors change from green to white is detected along a touchline of the field. A second chain of points is detected along a curved field line corresponding to part of a center circle of the field. For each of these chains of points, a second chain of points (not shown) may be detected at which pixel colors change from white to green (i.e. at the other side of the field line). FIG. 4D shows pixels of the same image frame 402 lying a set of equally spaced horizontal lines are scanned to detect changes of pixel color. A third chain of points is detected along the halfway line of the field. In both FIGS. 4C and 4D, additional points are detected, for example at the edges of the football 406. It is to be noted that the spacing of lines in FIGS. 4C and 4D are for illustrative purposes only, and the density of vertical and/or horizontal lines may be significantly higher.

Detecting changes of pixel colors along a vertical or horizontal line may involve analyzing pixels one by one and checking for a change in one or more color channels between subsequent pixels on the line (e.g. a change greater than a threshold). Alternatively, pixels may be analyzed in groups, for example using a sliding window approach, and a change in color may be recorded if the changed color is maintained for more than a threshold number of pixels (for example, three, five, or seven pixels). This may prevent a change of color being erroneously recorded due to fine-scale occlusions such as particles, fine-scale shadows, and so on. In another example, maximum values and/or minimum values of one or more color channels may be recorded for a group of neighboring pixels, and changes of color may be recorded in dependence on the maximum and/or minimum values, or the range of values, changing between groups of pixels. In some examples, any significant color change is recorded. In other examples, specific color changes are recorded (for example, green to white or white to green in the case of detecting field lines). The specific color changes may be dependent on information provided by the color analysis component 212, for example indicating range(s) of colors corresponding to grass. Changes of pixel colors may be detected based on changes in one or more color channels. Where a change in color is detected, the specific color values of pixels in the vicinity of the detected change may optionally be further analyzed to determine more precisely the location at which the change in color should be recorded, potentially enabling the location of the change of color to be determined at sub-pixel precision.

In the examples described above, horizontal and/or vertical line scans are used to detect features in an image frame. In other examples, other line scans such as diagonal line scans may be used. Furthermore, it may not be necessary to cover the entire width or the entire height of the image frame, for example if it is known that a region of interest for inserting objects lies within a specific portion of the image frame (e.g. based on other visual cues or prior knowledge of the layout of the scene, or based on the mask data 214 generated by the color analysis component 212).

As explained above, for each set of line scans (e.g. horizontal and vertical), respective sets of points may be detected indicating one or more types of color change (e.g. green to white). Points of the same type that are sufficiently close to one another according to a distance metric (such as absolute distance or distance in a particular direction) and from adjacent or nearby lines may then be connected, for example by numbering or otherwise labelling the points and storing data indicating associations between labels. The resulting set of links may then be filtered to determine chains of points corresponding to features of interest (such as field lines). For example, a set of points with at least two links may be identified and filtered to include points with links in substantially opposite directions, for example, links having the same gradient to within a given threshold. The value of the threshold may depend on whether the method is used to detect straight lines, or to detect curved lines as well. For a point having more than two links, the two best links may be identified (for example the two links with most similar gradients). This procedure may result in a set of points each having associated pairs of links. A flood-fill algorithm may then be applied to identify and label one or more chains of points, each of which may correspond to a feature of interest such as a field line or other line segment. In the present disclosure, “flood-fill” refers to any algorithm for identifying and labelling a set of mutually connected nodes or points. Well-known examples of algorithms that may be used for this purpose include stack-based recursive flood-fill algorithms, graph algorithms in which nodes are pushed onto a node stack or a node queue for consumption, and other connected-component labelling (CCL) algorithms.

In some examples, further analysis and/or filtering of the labeled chain(s) of points may be carried out. For example, further analysis may be performed to determine whether a given chain or point corresponds to a straight line segment or a curved line segment. For a given chain of points, this may be determined for example by computing changes in gradient between pairs of links associated with at least some points in the chain, and summing the changes of gradient (or magnitudes of the changes of gradient) over those points. If the sum (or average) of the changes of gradient lies within a predetermined range (for example if absolute value of the sum or average is less than a threshold value), then it may be determined that the chain of points corresponds to a straight segment. If the sum or average lies outside of the predetermined range, then it may be determined that the chain of points corresponds to a curved line segment.

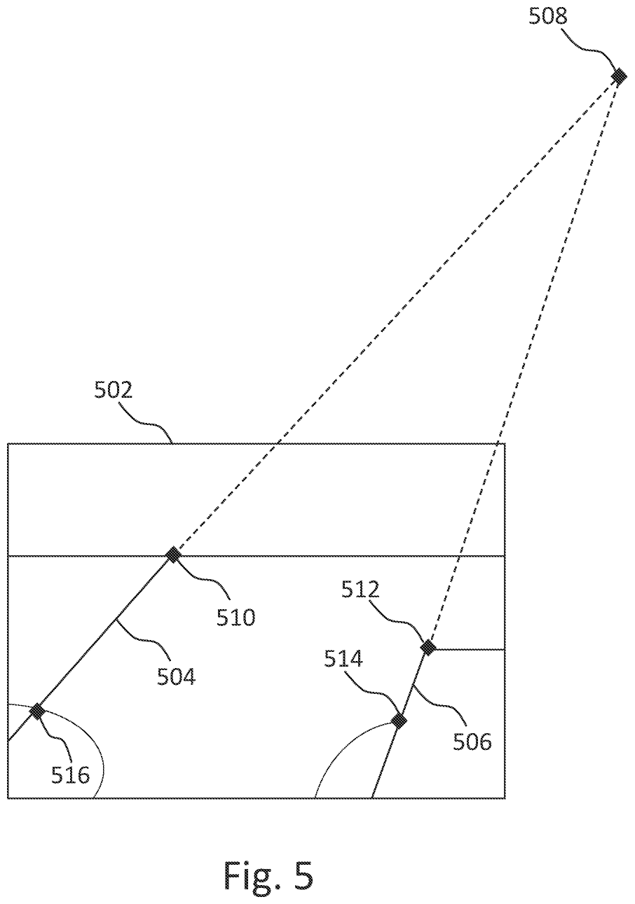

In certain settings, detected features may be discarded based on certain criteria. For example, straight line segments which are not either substantially parallel or perpendicular to a sports field in the three-dimensional environment may be erroneous and/or not useful for determining a transformation to be applied to an object. In cases where the environment is viewed from certain perspectives (e.g. a sports field viewed substantially side-on), then to filter out such line segments, a vanishing point may be determined based on intersections between two or more lines extrapolated from line segments detected using the horizontal line scan. Straight line segments detected by horizontal line scan and not pointing towards the vanishing point may be discarded. The vanishing point may be determined as an intersection between two or more lines extrapolated from detected straight line segments, provided that coordinates of the intersection fall within certain bounds (for example, above the farthest detected horizontal line and within predetermined horizontal bounds in the case of the substantially side-on perspective mentioned above). For multiple nearby intersections, the vanishing point may be determined as an average of these intersections. Intersections between lines that are very close to one another and/or have very similar gradients to one another (e.g. opposite sides of a given field line) may be omitted for the purpose of determining the vanishing point. In some examples, the vanishing point may be identified as a feature. FIG. 5 shows an example of an image frame 502 depicting part of a football field in which two straight line segments 504, 506 substantially perpendicular to a direction of the football field are detected, corresponding to (edges of) field lines. A vanishing point 508 is determined as an intersection of lines extrapolated from the line segments 504, 506. In addition to being used to filter out certain detected features, a detected vanishing point may be used in determining a transformation to be applied to an object to be inserted into an image frame.

Having detected a set of features in the input frame 202, the spatial configuration of the set of features may be determined, for example including positions, orientations and/or transformations of the detected features. The spatial configuration may include positions of one or more intersection points between lines or line segments detected in the input frame 202. FIG. 4E shows two intersection points 412, 414 between line segments detected in the image frame 402. FIG. 5 shows four intersection points 510, 512, 514, 516 between line segments detected in the image frame 502.

In addition to intersection points between lines or line segments, the spatial configuration of a set of features may include information derived from one or more curved lines or curved line segments. For example, curved line segments known to correspond to segments of a circle (such as a center circle of a football field) may be used to determine a location and dimensions of a bounding box within, or encompassing, the circle. Such a bounding box may be determined using any suitable coordinate system. For example, if a location of a vanishing point is known for the image frame 202 (e.g. from an intersection of lines or extracted from a perspective transformation matrix), then part of a bounding box corresponding to an individual circle segment (for example, a quarter circle segment) may be expressed in terms of angle relative to the vanishing point and vertical distance from a predetermined line such as the top of the input frame or the far edge of the football pitch). The location and dimensions of such a bounding box may for example be used to determine a position at which to place an object. Additionally, or alternatively, information derived from curved lines may be used to determine the transformation data 218. For example, a circle may be warped or deformed to best fit one or more curved line segments, and the warping used to determine the transformation data 218.

In some cases, a default spatial configuration of features within a scene may be known, for example where a map of the corresponding environment is available. For example, a default spatial configuration of features of a sports field may be known, either based on knowledge of the specific sports field or based on strictly-defined rules governing the dimensions of a sports field. In other examples, at least some dimensions may be unknown. In such cases, the unknown dimensions may be determined, as absolute values or relative to any known dimensions, by analysing the determined spatial configuration of features for a suitable image frame, such as an image frame in which the entirety or a large proportion of a football pitch is visible. The dimensions may be measured and recorded once within a given video stream, and may be relevant for determining a location at which to place the object. In an example of an image frame depicting a football pitch, dimensions of the two penalty boxes may by strictly defined, whereas other dimensions such as the length and width of the football pitch may vary between football pitches. Such dimensions may be determined based on the spatial configuration of features appearing within a suitable image frame, for example by comparing distances between suitable features.

As mentioned above, the feature analysis component 216 may generate transformation data 218, which may relate a spatial configuration of features detected within the input frame 202 with a default spatial configuration of the features. The transformation data 218 may for example encode a transformation matrix for mapping the default spatial configuration to the detected spatial configuration, or vice-versa. The transformation matrix may for example be a perspective transformation matrix or a rigid body transformation matrix. Generating the transformation data 218 may include solving a system of linear equations, which may have a single unique solution if the system is well-posed (e.g. if an appropriate number of features is used to determine the mapping). If too many features are used, the system may be overdetermined, in which case certain features may be omitted from the calculation or an approximate solution such as a least-squares approximation may be determined. For a given position and orientation (i.e. pose) of an advertisement or object with respect to the default spatial configuration of the features, the transformation data 218 may be used to transform or warp the object so as to determine a position, orientation, and appearance of the object for overlaying on the input frame 202. FIG. 4F shows an example of an advertisement 416 positioned on a football pitch 418. The position, orientation, and/or scale of the advertisement 416 relative to the football pitch 418 may be predetermined (for example, based on default parameters associated with the football pitch), or may be determined automatically in dependence on properties of the environment (e.g. football pitch) and object (e.g. advertisement), or may be manually selected by a human designer. FIG. 4G shows an example of an output video frame in which part of the advertisement 416 is overlaid on the image frame 402 to generate an output image frame 420. In this example, a perspective transformation is applied to the advertisement 416 such that the advertisement 416 appears at a correct orientation and position within the output image frame 420. Furthermore, the advertisement 416 is overlaid on pixels indicated by the binary mask 410 of FIG. 4B, and therefore appears occluded by the football player 404 so as to appear as part of the scene depicted in the output image frame 420.

The ad insertion module 120 in this example may further include a lighting analysis component 220, which is arranged to generate lighting data 222 for use in modifying colors of the object when generating the output frame 210. For example, the lighting data 222 may be used to modify color values of the ad data 206 prior to the ad data 206 being combined with the input frame 202. In some examples, the lighting data 222 may include, or be derived from, a blurred version of the input frame 202, for example by application of a blurring filter such as a Gaussian blurring filter. In some examples, the mask data 214 may be applied to a blurred version of the input frame 202 to generate the lighting data 222. In some examples, the lighting data 222 may be generated by pixelwise dividing the original input frame 202 by a blurred version of the input frame 202, or a function thereof. In one example, pixels of the lighting data 222 are determined as a ratio [original image/blurred image^{α}], where 0<α<1. In other examples, the lighting data 222 comprises the blurred version of the input frame 202, and the pixelwise division is performed at a later stage (e.g. when the output frame 210 is generated). Pre-multiplying fragments or pixels of the ad data 206 by the determined ratio at pixel positions where the fragments of the ad data 210 are to be inserted may replicate lighting detail present in the input frame 202, such as shadows, on parts of the object, so as to make the object appear more plausibly to be part of the scene. The lighting analysis component 220 may use alternative, or additional, methods to generate the lighting data 222. For example, the lighting analysis component may identify features or regions of the input frame 202 expected to be a certain color (for example white in the case of field lines on a sports field) and then use the actual color of the features or regions in the input frame 202 to infer information about lighting or other effects which may affect the color. The lighting data 222 may then represent or be derived from this information. In order to identify features or regions of the input frame 202 for this purpose, the lighting analysis component 220 may use information determined by the color analysis component 212 (for example, locations of field lines).

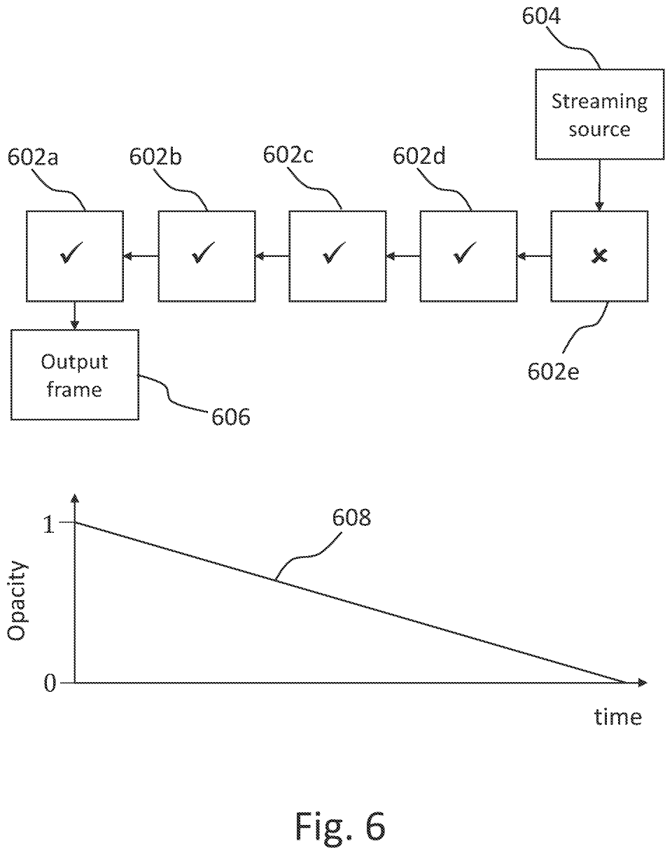

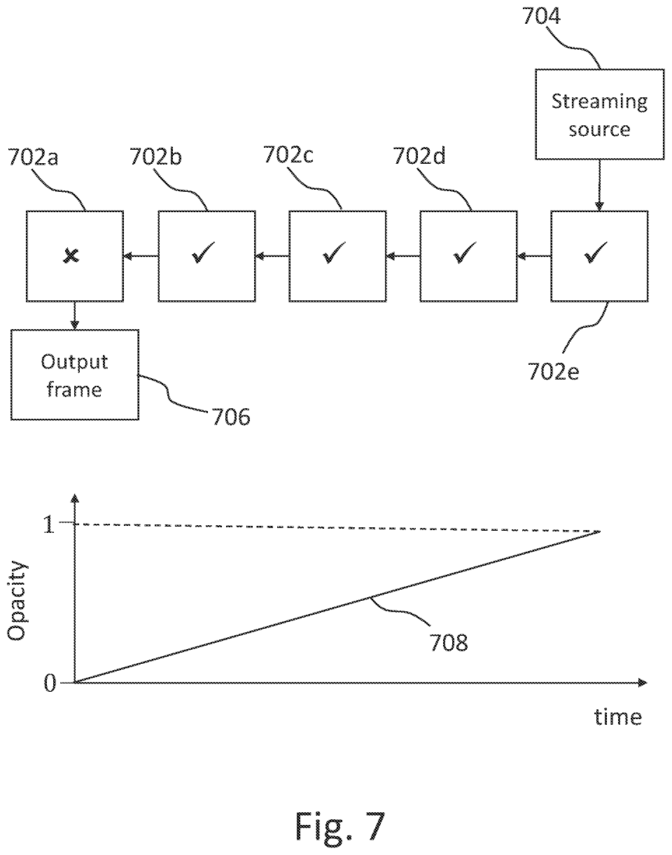

The ad insertion module 120 may include a frame generation component 224, which is arranged to generate the output image frame 210, which depicts the same scene as the input frame 202, but with an advertisement defined by the ad data 206 inserted within the scene. The output image frame 210 may be generated based at least in part on the input frame 202, the ad data 206, and one or more of the mask data 214, the transformation data 218, and the lighting data 222. For example, a position at which the advertisement is to be inserted may be determined with respect to a default spatial configuration of features within the scene depicted in the input frame 202. A transformation indicated by, or derived from, the transformation data 218 may then be applied to the advertisement to determine pixel positions for fragments of the advertisements. The fragments of the advertisement may then be filtered using the mask data so as to exclude fragments occluded by other objects in the scene. The color of the remaining fragments may then be modified using the lighting data 222, before being overlaid on, or blended with, pixels of the input frame 202. In other examples, the masking may be performed after the color modification. In examples where the ad data 206 is blended with the input frame 202, the opacity of the advertisement may depend on preceding or subsequent image frames, as discussed in detail with reference to FIGS. 6 and 7. In some examples, gamma-correct blending may be used to improve the perceived quality of the resultant image.

The methods performed by the ad insertion module 120 may be performed independently for individual image frames. Alternatively, one or more of the operations performed by the ad insertion module, such as determining a statistically significant region of a color space, determining mask data, determining a transformation, or determining lighting information, may involve averaging or otherwise combining values computed over multiple image frames. This may have the effect of temporally stabilizing the image processing operations and mitigating artefacts caused by anomalous image frames or erroneous values computed in respect of specific image frames. For example, values may be averaged or combined for sequences of neighboring image frames using a moving window approach. In case of an outlier or anomalous value within a given image frame, values determined from one or more neighboring image frames (before and/or after the given image frame in the video stream) may be used. Furthermore, certain steps such as determining a statistically significant region of a color space may not need to be carried out for all image frames, and may be performed for a subset of image frames of the input video stream.

In some implementations, the image processing functions of the color analysis component 212, the feature analysis component 216, and the lighting analysis component 220 are performed for multiple image frames of a video stream prior to the ad insertion step being carried out. In this way, if any of these image processing functions are unsuccessful for a given image frame, for example due to an error or a lack of processing resources being available, then the ad insertion can be modified. For example, if it is determined that an advertisement cannot or should not be inserted in a given image frame, then for a sequence of image frames prior to the given image frame, the frame generation component 224 may be configured to reduce the opacity of the advertisement between image frames so as to progressively fade the advertisement out of view. If it is then determined that the advertisement should be inserted in a later image frame, the frame generation component 224 may vary the opacity of the advertisement between subsequent image frames so as to progressively fade the advertisement into view. Fading the advertisement into and out of view in this way may be preferable to letting the advertisement flash rapidly in and out of view for sequences of image frames in which one or more of the image processing steps is unstable.

FIG. 6 shows an example of a sequence of five input image frames 602a, . . . , 602e received from a streaming source 604. In this example, each input image frame 602 is processed on arrival from the streaming source 604 in an attempt to generate mask data, transformation data, and/or lighting data as discussed above. The processing also includes setting a flag (or other data) to indicate whether the processing has been successful for the image frame 602. If the processing has been successful, an object is inserted into the input image frame 602, using the generated data, to generate an output image frame 606. The output image frame 606 may then be added to an output video stream. In this example, the generating of the output image frame 606 is performed with a delay of several frames (in this example, four frames), resulting in a small delay to the output video stream. In this example, the image processing steps have been flagged as successful for input image frames 602a-602d, as indicated by the ticks in FIG. 6. However, at least one of the image processing steps has been flagged as unsuccessful for input image frame 602e, as indicated by the cross in FIG. 6. In response to the flag indicating that the processing has been unsuccessful, the opacity of the object inserted into the input image frames 602a-602d is progressively reduced so as to fade the object out of view over the course of the sequence of input image frames 602, as shown by the graph line 608. In this case, the opacity reduces linearly with time or frame number, though it will be appreciated that other functions may be used, e.g. to smoothly fade out the object. This progressive fading is made possible by the delay between the initial image processing (in which mask data, transformation data, and optionally lighting data is generated) and the step of actually inserting the object into the image frames.

FIG. 7 illustrates the reverse situation of FIG. 6. In FIG. 7, one or more image processing steps have been flagged as unsuccessful for input image frame 702a, but then successful for each of input image frames 702b-e. In this case, the opacity of the object may be progressively increased so as to fade the object into view over the course of the sequence of input image frames 702, as shown by the graph line 708. In cases where image processing becomes unstable such that the flag indicates a mix of successful and unsuccessful image processing within a given sequence, it may be desirable not to insert the object until the image processing stabilizes as indicated by a predetermined number of successful flags in a row, at which point the object may be faded into view. It will be appreciated that other criteria may be applied to determine when and whether to fade an object into and/or out of view, as made possible by the delayed output strategy described herein.

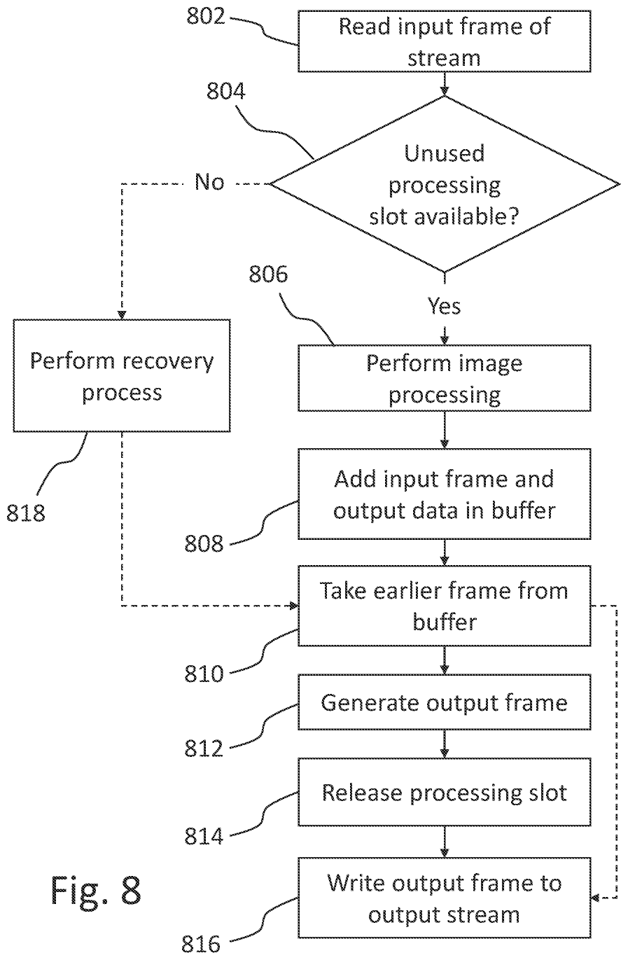

FIG. 8 shows an example of a method of managing processing resources at a computing system, for example to insert an object into image frames of a video stream (such as a live video game stream) in real-time or substantially real-time. The method proceeds with reading, at 802, an input frame of an input video stream. If it is determined, at 804, that an unused processing slot is available, then the method may continue with performing, at 806, image processing steps using the available processing slot, for example as described in relation to the color analysis component 212, the feature analysis component 216, and the lighting analysis component 220 of FIG. 2.

If successful, the image processing at 806 may generate output data including mask data, transformation data and/or lighting data, along with a flag or other data indicating that the image processing has been successful. If unsuccessful, the output data may include a flag indicating that the image processing has been unsuccessful. At 808, the input frame and the output data generated at 806 may be added to a buffer, such as a ring buffer or circular buffer which is well-suited to first-in-first-out (FIFO) applications. At 810, an earlier input frame is taken (selected) from the buffer. The number of frames between the earlier input frame and the current input frame may depend on a number of frames over which it is desired for the object to fade into or out of view as explained above. At 812, an output frame is generated by inserting the object into the earlier input frame, using the output data previously generated for the earlier image frame. The opacity of the object may depend on whether the image processing at 806 is successful for the current image frame. At 814, the processing slot may be released, thereby becoming available to perform image processing for a later image frame in the input stream. At 816, the output frame generated at 812 may be written to an output video stream.

If it is determined, at 804, that no unused processing slot is available, then the method may continue with performing, at 818, a recovery process. The recovery process may for example include skipping the image processing of 806 and/or the generating of an output frame at 812. In one example, the object may be faded out of view in the same way as discussed above in relation to a failure of the image processing of 806. Alternative recovery options may be deployed, for example reconfiguring parts of the image processing and/or data to a lower level of detail or resolution, which may free up processing resources and enable the object insertion to continue, though with potentially compromised precision and/or a lower resolution output.

At least some aspects of the examples described herein with reference to FIGS. 1-8 comprise computer processes or methods performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

The above embodiments are to be understood as illustrative examples. Further embodiments are envisaged. For example, the systems and methods described herein are not limited to inserting adverts into video streams featuring footage of video game play, but may be used to insert other objects into video data more generally. For example, the video data may feature camera footage of a real-life sports event or other real-life scene from a television program or film. Objects to be inserted into video data according to the disclosed methods may be two-dimensional or three-dimensional, static or animated.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system comprising at least one processor and at least one memory storing instructions which, when executed by the at least one processor, cause the at least one processor to carry out operations comprising:
obtaining an input image frame of an input video stream;
determining a statistically significant region of a color space represented by pixels of the input image frame; and
generating an output image frame of an output video stream by overlaying an object on pixels of the input image with colors corresponding to the statistically significant region of the color space.

2. The system of claim 1, wherein the operations further comprise:
determining a spatial configuration, within the input image frame, of one or more features of a predetermined set of features;
determining a transformation relating the determined spatial configuration of the one or more features to a default spatial configuration of the one or more features;
transforming the object in accordance with the determined transformation prior to the overlaying.

3. The system of claim 2, wherein determining the spatial configuration, within the input image frame, of the one or more features comprises:
identifying points on a plurality of paths across the input image frame at which adjacent pixels colors change in a mutually consistent manner;
connecting the identified points between paths of the plurality of paths to generate a chain of points; and
identifying a first feature of the predetermined set of features based on the generated chain of points.

4. The system of claim 2, wherein determining the spatial configuration, within the input image frame, of the one or more features comprises:
identifying a plurality of line segments in the input image frame; and
determining locations within the input image frame of intersection points between at least some of plurality of line segments,
wherein the determined spatial configuration includes the determined locations within the input image frame of the intersection points.

5. The system of claim 2, wherein determining the spatial configuration, within the input image frame, of the one or more features comprises:
identifying a plurality of line segments in the input image frame;
determining a vanishing point based on at least some of the plurality of line segments;
discarding a first line of the plurality of line segments based at least in part on the first line not pointing towards with the vanishing point; and
determining the spatial configuration in dependence on line segments of the plurality of line segments remaining after the discarding of the first line segment.

6. The system of claim 2, wherein the operations further comprise determining, based at least in part on the determined spatial configuration of the one or more features, a dimension associated with the default spatial configuration of the one or more features.

7. The system of claim 1, wherein determining the transformation is based at least in part on the spatial configuration, within a plurality of image frames of the input video stream, of the one or more features.

8. The system of claim 1, wherein generating the output frame comprises:
generating mask data indicating pixels of the input image frame with colors in the determined statistically significant region of the color range; and
overlaying the object on pixels of the input image frame indicated by the mask data.

9. The system of claim 1, wherein:
the mask data has values that vary continuously from a first extremum for pixels with colors inside the statistically significant region of the color space to a second extremum for pixels with colors outside the statistically significant region of the color space; and
the overlaying comprises blending the object with pixels of the input image frame in accordance with the values indicated by the mask data.

10. The system of claim 1, wherein determining the statistically significant region of the color space for pixels of the input image frame comprises:
determining, for pixels of the input image frame, a statistically significant range of values of a first color channel; and
determining, for pixels of the input image frame with values of the first color channel within the statistically significant range, a statistically significant range of values of a second color channel,
wherein the statistically significant region of the color range has values of the first and second color channels in the determined statistically significant ranges.

11. The system of claim 10, wherein determining the statistically significant region of the color space for pixels of the input image frame further comprises:
determining, for pixels of the input image frame with values of the first color channel within the statistically significant range for the first color channel and values of the second color channel in the statistically significant range for the second color channel, a statistically significant range of values of a third color channel,
wherein the statistically significant region of the color range comprises values of the first, second, and third color channels in the determined statistically significant ranges for first, second, and third color channels.

12. The system of claim 1, wherein:
the statistically significant region of the color space is a first statistically significant region of the color space;
the operations further comprise determining a second statistically significant region of the color space represented by pixels of the input image frame; and
generating the output image frame further comprises overlaying the object on pixels of the input image frame with colors corresponding to the second statistically significant region of the color space.

13. The system of claim 1, wherein the operations further comprise downscaling the input image frame prior to determining the statistically significant region of the color space represented by pixels of the input image frame.

14. The system of claim 1, wherein:
the input image frame has a set of input pixel values; and
the operations further comprise:
applying a blurring filter to at least some input pixel values of the input image frame to generate blurred pixel values for the input image frame;
determining, for the input pixels values, lighting values based at least in part on the input pixel values and the blurred pixel values; and
prior to the overlaying, modifying colors of the transformed object in dependence on the determined lighting values.

15. The system of claim 1, wherein the input image frame is a first image frame of the input video stream, the operations further comprising:
determining that the object is not to be overlaid on a second image frame of the input video stream, the second image frame being subsequent to the first image frame; and
generating a sequence of image frames of the output video stream by overlaying the object on pixels of image frames between the first image frame and the second image frame in the input video stream,
wherein an opacity of the object varies over a course of the sequence of image frames, thereby to progressively fade the object out of view in the output video stream.

16. The system of claim 14, the sequence of image frames is a first sequence of image frames, the operations further comprising:
determining that the object is to be overlaid on a third image frame of the input video stream, the third image frame being subsequent to the second image frame; and
generating a second sequence of image frames of the output video stream by overlaying the object on pixels of image frames following the third image frame in the input video stream,
wherein the opacity of the object varies over a course of the second sequence of image frames, thereby to progressively fade the object into view in the output video stream.

17. The system of claim 1, wherein determining the statistically significant region of the color space is based at least in part on colors of pixels of a plurality of image frames of the input video stream.

18. The system of claim 1, wherein obtaining the input image frame comprises receiving the input video stream from a video gaming system.

19. A computer-implemented method comprising:
obtaining an input image frame of an input video stream;
determining a statistically significant region of a color space represented by pixels of the input image frame; and
generating an output image frame of an output video stream by overlaying an object on pixels of the input image with colors corresponding to the statistically significant region of the color space.

20. One or more non-transient storage media comprising computer-readable instructions which, when executed by one or more processors, cause the one or more processors to carry out operations comprising:
obtaining an input image frame of an input video stream;
determining a statistically significant region of a color space represented by pixels of the input image frame; and
generating an output image frame of an output video stream by overlaying an object on pixels of the input image with colors corresponding to the statistically significant region of the color space.
